(19) United States
(12) Patent Application Publication
(10) Pub. No.: US 2003/0007636 A1
(43) Pub. Date: Jan. 9, 2003

(54) Method and apparatus for executing a cryptographic algorithm using a reconfigurable datapath array

(76) Inventors: Vladimir Castro Alves, Irvine, CA (US); Ming Hau Lee, Irvine, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/888,838

(22) Filed: Jun. 25, 2001

(51) Int. Cl. H04K 1/04

(52) U.S. Cl. 380/37

(57) ABSTRACT

A digital signal processing apparatus and method for executing a block cipher routine. A method includes configuring a portion of an array of independently reconfigurable processing elements for performing the block cipher routine. The method further includes executing the block cipher routine on data blocks received at the configured portion of the array of processing elements. The non-configured portion of the array can be shut down to conserve power. An apparatus includes a context memory for storing one or more context instructions for performing the block cipher routine. The apparatus further includes an array of independently reconfigurable processing elements, each of which is responsive to a context instruction for being configured to execute a portion of the block cipher routine.

### BACKGROUND OF THE INVENTION

The present invention generally relates to digital signal processing, and more particularly to a method and apparatus for executing a block cipher routine using a reconfigurable datapath array.

Digital signal processing (DSP) is growing dramatically. Digital signal processors are a key component in many communication and computing devices, for various consumer and professional applications such as communication of voice, video, and audio signals.

The execution of DSP involves a trade-off of performance and flexibility. At one extreme, that of high-performance, hardware-based application-specific integrated circuits (ASICs) are made to execute a specific process. Hardware-based processing can be orders of magnitude faster than software processing. However, hardware-based processing circuits are either hard-wired or programmed for a limited, and inflexible, range of functions. At the other extreme, that of flexibility, software running on a multi-purpose or general purpose computer is easily adaptable to any type of processing. However, software-based processing offers limited performance. A general purpose processor executing a computer program is hampered by clock speed and the inability to execute a large number of processes in parallel.

Devices performing DSP are increasingly smaller, more portable, and consume less energy. However, the size and power requirements of a DSP device limit the amount of processing resources that can be built into it. Thus, there is a need for a flexible processing arrangement, i.e. one that can flexibly perform many different functions, yet which can also achieve high performance of a dedicated circuit.

One example of DSP is secure processing of data communications. Any data that is transmitted, whether text, voice, audio or video, is subject to attack during its transmission and processing. A flexible, high-performance system and method can perform many different types of processing on any type of data, including processing of cryptographic algorithms.

### BRIEF DESCRIPTION OF THE DRAWING

FIG. 1 shows a data processing architecture according to the invention.

FIG. 2 illustrates a dynamically reconfigurable array of processing elements in accordance with the invention.

FIG. 3 illustrates the internal structure of one reconfigurable processing cell.

FIGS. 4A and 4B show several hierarchies of interconnection among reconfigurable cells within an array.

### DETAILED DESCRIPTION OF THE PREFERRED EMBODIMENTS

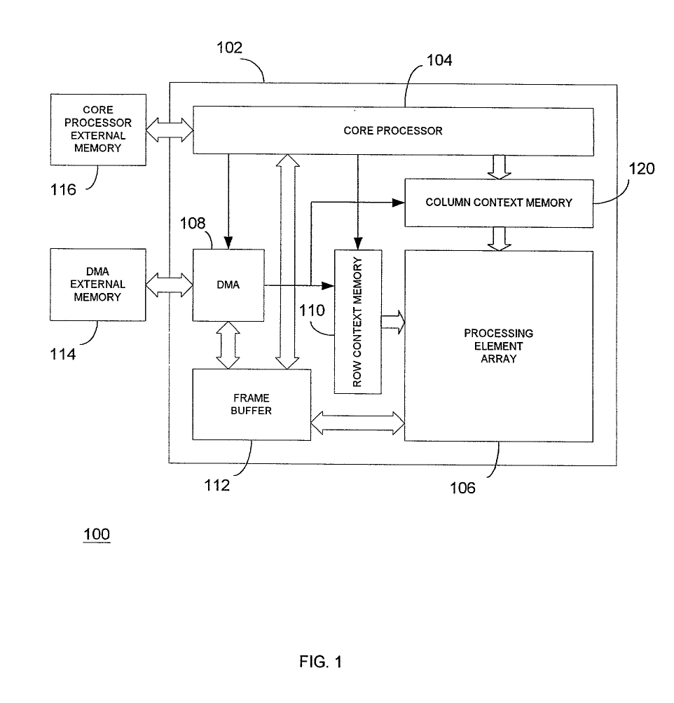

FIG. 1 shows a data processing architecture 100 in accordance with the invention. The data processing architecture 100 includes a processing engine 102 having a software programmable core processor 104 and a reconfigurable array of processing elements 106. The array of processing elements includes a multidimensional array of independently programmable processing elements, each of which includes logical elements that are configured for performing a specific function.

The core processor 104 is a MIPS-like RISC processor with a scalar pipeline. The core processor includes registers and functional units. In one embodiment, the functional units comprise an arithmetic logic unit (ALU), a bit shifter, and a memory. In addition to performing typical RISC-type instructions, the core processor 104 is provided with specific instructions for controlling other components of the processing engine 102. These include instructing the array of processing elements 106 and a direct memory access (DMA) controller 108 that provides data transfer between external memory 114 and 116 and the processing elements. The external memory includes a DMA external memory 114 and a core processor external memory 116.

A frame buffer 112 is provided between the DMA controller 108 and the array of processing elements 106 to facilitate the data transfer. The frame buffer 112 acts as an internal data cache for the array of processing elements 106. The dual-ported frame buffer 112 makes memory access transparent to the array of processing elements 106 by overlapping computation with data load and store. Further, the input/output datapath from the frame buffer 112 allows for broadcasting of one byte of data to all of the processing elements in the array 106 simultaneously. Data transfers to and from the frame buffer 112 are also controlled by the core processor 104, and through the DMA controller 108.

The DMA controller 108 also controls the transfer of context instructions into context memory 110, 120. The context memory provides a context instruction for configuring the array of processing elements 106 to perform a particular function, and includes a row context memory 110 and a column context memory 120 where the array of processing elements is an M-row by N-column array. Reconfiguration is done in one cycle by caching several context instructions from the external memory 114.

In a specific exemplary embodiment, the core processor is 32-bit. It communicates with the external memory 114 through a 32-bit data bus. The DMA 108 has a 32-bit external connection as well. The DMA 108 writes one 32-bit data to context memory 110, 120 each clock cycle when loading a context instruction. However, the DMA 108 can assemble the 32-bit data into 128-bit data when loading data to the frame buffer 112, or disassemble the 128-bit data into four 32-bit data when storing data to external memory 114. The data bus between the frame buffer 112 and the array of processing elements 106 is 128-bit in both directions. Therefore, each reconfigurable processing element in one column will connect to one individual 16-bit segment output of the 128-bit data bus. The column context memory 120 and row context memory 110 are each connected to the array 106 by a 256-bit (8×32) context bus in both the column and row directions. The core processor 104 communicates with the frame buffer 112 via a 32-bit data bus. At times, the DMA 108 will either service the frame buffer storing/load, row context loading or column context loading. Also, the core processor 104 provides control signals to the frame buffer 112, the DMA 108, the row/column context memories 110, 120, and array of processing elements 106. The DMA 108 provides control signals to the frame buffer 112, and the row/column context memories 110, 120.

The above specific embodiment is described for exemplary purposes only, and those having skill in the art should recognize that other configurations, datapath sizes, and layouts of the reconfigurable processing architecture are within the scope of this invention. In the case of a two-dimension array, a single one, or portion, of the processing elements are addressable for activation and configuration. Processing elements which are not activated are turned off to conserve power. In this manner, the array of reconfigurable processing elements 106 is scalable to any type of application, and efficiently conserves computing and power resources.

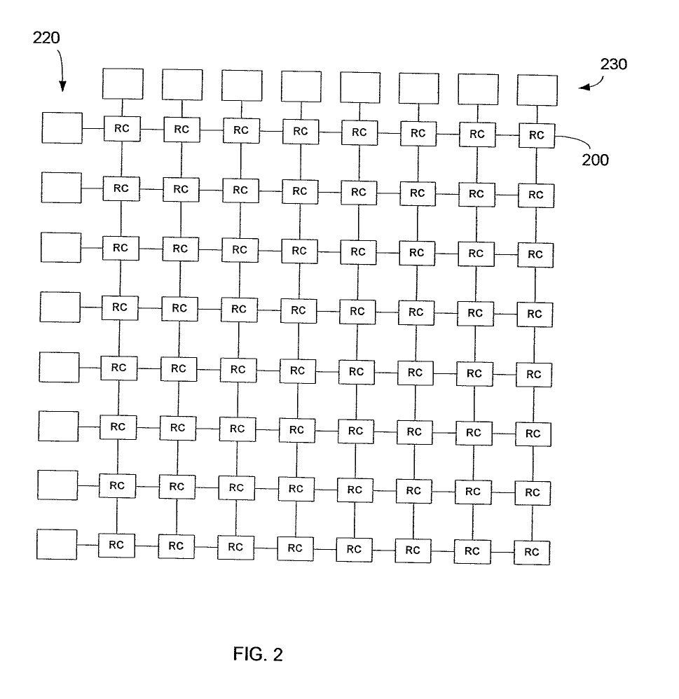

FIG. 2 shows a dynamically reconfigurable array of processing elements 106 in accordance with the invention. The array 106 includes an M row×N column array of independently-configurable processing elements 200, otherwise referred to herein as reconfigurable cells (RCs) 200. In one embodiment, the array 106 is an 8×8 array of RCs 200. Each RC 200 includes processing and logic elements which, when programmed, execute one or more logic functions. Each row M is connected to a row decoder 220. The row decoder 120 is configured to address and instruct all RCs 200 in each row. Each column N is connected to a column decoder 230. The column decoder is configured to address and provide instructions to all RCs 110 in each column. Thus, a row address signal from the row decoder 220 is gated with a column address signal from the column decoder 230 at each RC 200, to activate and instruct a selected one or more of the RCs 200 in the array.

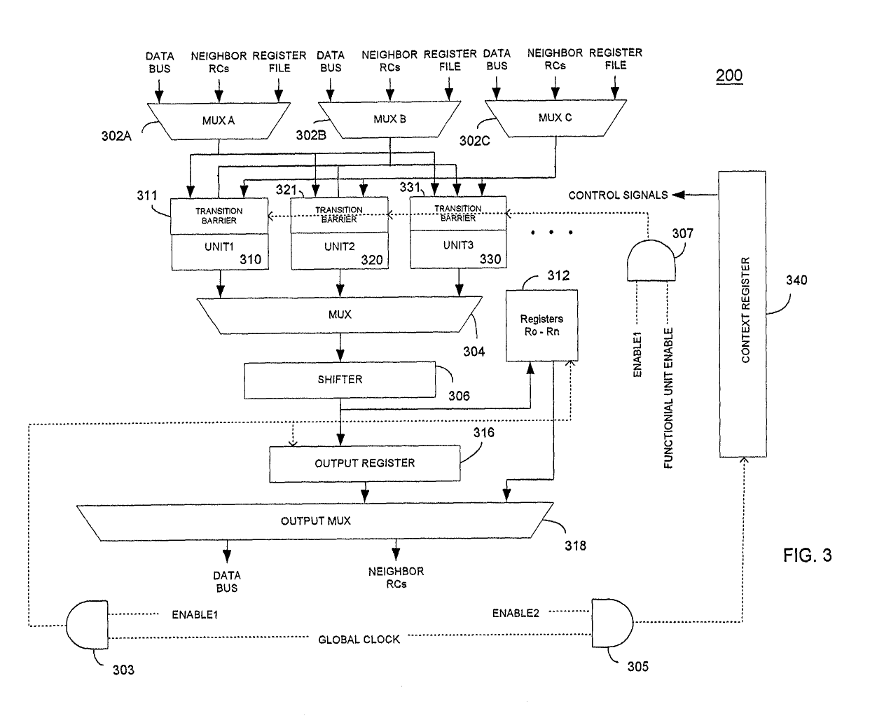

FIG. 3 illustrates the internal structure of an RC 200, showing one or more functional units 310, 320 and 330. While only three functional units are shown, the number of functional units is merely exemplary, and those having skill in the art would recognize that any combination of functional units can be used within the teachings of the invention. A combination of active functional units 310, 320 and/or 330 defines an operation of the RC, and represents the function executed by the RC 200 during a processing cycle.

Suitable functional units can include, without limitation, a Multiply-and-Accumulate (MAC) functional unit, an arithmetic unit, and a logic unit. Other types of functional units for performing functions are possible. The functional units 310, 320 and/or 330 are configured within the RC 200 in a modular fashion, in which functional units can be added or removed without needing to reconfigure the entire RC. In particular, by adding functional units, a range of operations of the RC 200 is expandable and scalable. The modular design of the exemplary embodiment also makes decoding of the function easier.

The functional units are controlled and activated by a context register 340. The context register 340 latches a context instruction upon each processing cycle, and provides the context instruction to the appropriate functional unit(s). Depending upon the structure and logic of the group of functional units, and based on the context of the RC, more than one functional unit can be activated at a time. The functional units are configured to execute logical operations which include, without limitation, XOR, OR, AND, store, shift, and truncate. Other functions are easily configured.

Each RC 200 contains a storage register 312 for temporarily storing the functional unit computation results. In one embodiment, the results from each functional unit multiplexed together by multiplexer 304, outputted to a shifter 306, and provided to an output register 316. The data output of the shifter 306 is also provided to the storage register 312, where it is temporarily stored until replaced by a new set of output data from the functional units 310, 320 and/or 330. The output register 316 sends the output data to an output multiplexer 318, from which the output data, representing a processing result of the reconfigurable cell, is sent to either the data bus, to a neighboring cell, or both.

An ENABLE1 signal is gated with a clock signal at AND gate 303, for controlling most or all of the sequential logic elements within the RC 200. The ENABLE 1 signal is gated with a functional unit enable signal at AND gate 307, for activating transition barriers 311, 321, and 331, which in turn prevent input changes from propagating to the internal components. At the same time, all the clocks to the registers, including the context register 340, are disabled. As a result, no power is consumed in the RC and the RC does not process any data. The ENABLE1 signal thus controls the flow of data to be operated upon by the RC 200.

An ENABLE2 signal is gated with the clock signal at AND gate 305 for controlling the context register 340. The ENABLE2 signal controls the flow of the context instruction to the RC 200 for controlling the operation of the RC 200. The ENABLE1 and ENABLE2 signals are based on the mask signals provided by the row and column mask registers 210 and 220, respectively, and the execution mode generator 230, as shown in FIG. 2. By selectively enabling a subset of RCs 200 in the array, it is possible to scale the amount of power consumed, such that the consumption of power can be controlled, particularly when needed, such as when power is scarce, etc.

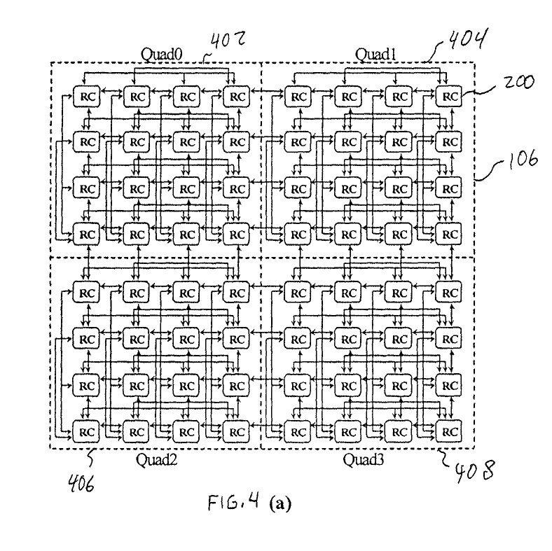

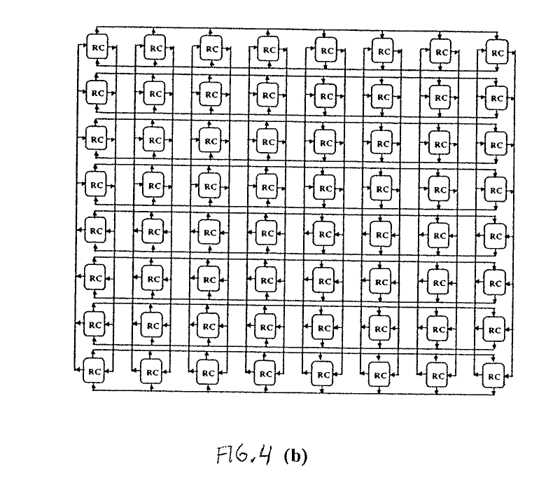

The reconfigurable cells 200 in an array 106 are interconnected according to one or more hierarchical schemes. FIG. 4A illustrates one possible interconnection scheme having two levels of hierarchy, for an exemplary 8×8 array of RCs 200. First, RCs 200 are grouped into four quadrants: QUAD0 402, QUAD1 404, QUAD2 406, and QUAD3 408, in which each RC 200 in a quadrant is directly connected to all other RCs 200 in the same quadrant. Additionally, adjacent RCs from two quadrants are connected via “express lane” interconnects, which enable an RC in one quadrant to broadcast its processing result to RCs in another quadrant, as shown in FIG. 4B. Thus the second layer of interconnectivity provides complete row and column connectivity within an array 106.

The above described digital processing architecture 100 and reconfigurable processing array 106 provides a foundation for overcoming limitations of hardware-specific or software-specific implementations of signal processing systems and methods. In a specific embodiment of the invention, the digital processing architecture is configured for executing a block cipher routine, achieving the high performance of a hardware implementation such as an ASIC, yet providing the flexibility and scalability of software executed by general purpose processors.

A block cipher routine is one type of cryptographic algorithm executed for generating cyphertext. A block cipher routine includes a encryption/decryption method in which a cryptographic key and algorithm are applied to a block of data, as opposed to one bit of data at a time. Cryptography is becoming more important as bandwidth and the amount of data exchanged increases.

One example of the increased importance of security is found in the newly formed Universal Mobile Telecommunications System (UMTS), which is a so-called “third generation (3G)” broadband, packet-based transmission of text, digitized voice, video and multimedia at data rates up to an surpassing 2 Mbps, developed by the Third Generation Partnership Project (3GPP). The UMTS offers a consistent suite of services to mobile computer and phone users wherever they are located in the world. Users will have access to UMTS-based networks through a combination of terrestrial wireless and satellite transmissions, using multi-mode devices. For effective UMTS access, these multi-mode devices must be small, power conservative, and secure.

Within the security architecture of 3G protocols are two standardized cryptographic algorithms: a confidentiality algorithm f8 and an integrity algorithm f9. The confidentiality algorithm f8 is a stream cipher that is used to encrypt/decrypt blocks of data under a confidentiality key (CK). The f9 algorithm provides for protection of data and content. The f8 and f9 algorithms are specified in the 3GPP Confidentiality and Integrity Algorithms f8 and f9 Specification Version 1.0, developed by the 3GPP, and hereby incorporated by reference for all purposes.

These algorithms are specified in the 3GPP Confidentiality and Integrity Algorithms KASUMI Algorithm Specification Version 1.0, also incorporated by reference herein for all purposes. The f8 and f9 algorithms are based on the KASUMI block cipher core, developed by Mitsubishi Electronics Corporation. The KASUMI block cipher produces a 64-bit output from a 64-bit input under the control of a 128-bit key. The confidentiality algorithm f8 uses the KASUMI block cipher in an output-feedback mode as a keystream generator. The algorithm f9 employs the KASUMI core for the integrity function.

In accordance with the invention, by mapping a block cipher routine, such as KASUMI for example, onto the digital processing architecture 100, it is possible to realize the performance of an ASIC yet achieve the flexibility of software running on a general purpose computer processor.

Table 1 shows one embodiment of a method of the invention, whereby the computational part of a block cipher routine can be executed with as few as two RCs. In a specific example of the embodiment, four RCs are initially activated for loading a 64-bit input data block and 64-bit cipher subkeys KL, KO, and KI, according to the 128-bit KASUMI cryptographic key.

Initially, the 64-bit input data block is divided into two 32-bit blocks, Xl and Xr. The I-th phase of the algorithm, i varying from 1 to 8, operates as follows:

a) if i=1, 3, 5 and 7 then:

Xrᵢ₊₁=Xli;

Xlᵢ₊₁=Xrᵢ xor FOᵢ(FLᵢ(Xlᵢ, KLᵢ), KOᵢ).

b) if i=2, 4, 6 and 8 then

Xrᵢ₊₁=Xli;

Xlᵢ₊₁=Xrᵢ xor FLᵢ(FOᵢ(Xlᵢ, KOᵢ), KLᵢ);

FL is a 32-bit non-linear function that, in each phase, is derived from a 32-bit subkey KL. The 32-bit input data block is divided into two 16-bit blocks, Ylin and Yrin and the 32-bit KLᵢ sub-key is also split into two 16-bits keys KLᵢ₁ and KLᵢ₂. The output of the FL function is the concatenation of two Ylout and Yrout where:

Ylout=Ylin xor (shift_left(Yrout or KLᵢ₂)

Yrout=Yrin xor (shift_left(Ylin or KLᵢ₁)

FO is a 32-bit non-linear function that, in each phase, is derived from a 32-bit subkey KO and the FI sub-function. The 32-bit input data block is divided into two 16-bit blocks, Zlin and Zrin and six 16-bit sub-keys are used, namely KOᵢ₁, KOᵢ₂, KOᵢ₃, KIᵢ₁, KIᵢ₂ and KIᵢ₃. The output of the FO function is the concatenation of two Zlout and Zrout where:

Zlout=(Zrin xor (FIᵢₗ, (KIᵢ₁, (KOᵢ₁ xor Zlin)))) xor (FIᵢ₂(KIᵢ₂,(KOᵢ₂ xor Zrin)))

Zrout=Zlout xor (FI_{I3}(KI_{I3},(KO_{I3} xor (Zrin xor (FI_{I1}(KI_{I1},(KO_{I1} xor Zlin)))))))

FI is a 16-bit non-linear function that, in each phase, is derived from a 16-bit subkey KI. The 16-bit input data block is divided into a 9-bit block and a 7-bit block, Wlin and Wrin and two sub-keys are used, namely KIᵢⱼ₁, and KIᵢⱼ₂. The output of the FI function is the concatenation of two Wlout and Wrout where:

Wlout=trun(Wrout) xor S7 (KIᵢⱼ₁ xor (trun (zero_ext(Wrin) xor S9 (Wlin)) xor S7(Wrin))

Wrout=zero_ext(KI_{IJ1} xor (trun(zero_ext(Wrin) xor S9 (Wlin)) xor S7(Wrin)) xor S9 (KI_{IJ2} xor (zero_ext(Wrin) xor S9 (Wlin)))

The truncate function which provides a 7-bit block out of a 9-bit block by eliminating the two most significant bits is denoted by trun( ). The zero extension function which provides a 9-bit block out of a 7-bit block by appending two zeros to the MSB is denoted by zero_ext( ).

The basic operations for which a selected RC is programmed according to a context instruction includes, without limitation, a Look Up Table (LUT), XOR, truncation (7 or 9 bits), logic shift left (1 position), logic shift right (1 position), OR, AND, and storing. The KASUMI subfunction FO is executed by two RCs in 46 cycles, as shown in Table 2. The KASUMI subfunction FL is executed by two RCs in 4 cycles, as shown in Table 3. The subfunction FI, itself a subfunction of the subfunction FO, is executed by two RCs in 14 cycles. Referring back to Table 1, one entire KASUMI cipher block routine is executed using four RCs for loading and latching data and subkeys KL, KO and KI, and using two RCs for computational execution of the subfunctions FL and FO, the latter of which includes the subfunction FI.

TABLE 1
KASUMI building block

| Cycle | RC #1 op | RC #2 op | RC #3 op | RC #4 op |
|---|---|---|---|---|
| 1 | Load KLi key | Load KLi key | Load KOi | Load Mi |
| | (MSB) | (LSB) | key | key |
| 2 to | FL i | FL i | — | — |
| 5 | | | | |
| 5 to | FO i | FO i | — | — |
| 51 | | | | |
| 52 | XOR | XOR | — | — |
| 53 | Load KLi + 1 | Load KLi + 1 | Load KOi + 1 | Load KIi + 1 |
| | key | key | key | key |
| | (16 MSB) | (16 LSB) | | |
| 52 to | FO i + 1 | FO i + 1 | — | — |
| 99 | | | | |
| 100 to | FL i + 1 | FL i + 1 | — | — |
| 103 | | | | |

Kasumi algorithm is built by repeating the table above for i = {1, 3, 5, 7}

TABLE 2
Function FO

| Cycle | Data path cell #1 operation | Data path cell #2 operation |
|---|---|---|
| 1 | XOR | — |
| 2 to 15 | Function FI | function FI |
| 16 | XOR | XOR |
| 17 to 30 | Function FI | function FI |
| 31 | XOR | XOR |
| 32 to 45 | Function FI | function FI |
| 46 | — | XOR |

TABLE 3
Function FL

| Cycle | Data path cell #1 operation | Data path cell #2 operation |
|---|---|---|
| 1 | AND / SHIFT | — |
| 2 | — | XOR |
| 3 | OR / SHIFT | — |
| 4 | XOR | — |

TABLE 4
Function FI

| Cycle | Data path cell #1 operation | Data path cell #2 operation |
|---|---|---|
| 1 | STORE (LUT) MSB 9 bits | — |
| 2 | STORE (LUT) LSB 7 bits | — |
| 3 | — | — |
| 4 | — | XOR |
| 5 | STORE (LUT) | TRUNCATE |
| 6 | XOR | — |
| 7 | XOR (LUT) | XOR (LUT) |
| 8 | — | — |
| 9 | — | — |
| 10 | XOR | STORE |
| 11 | TRUNCATE | — |
| 12 | — | XOR |
| 13 | assemble in 16 bits word | assemble in 16 bits word |
| 14 | assemble in 16 bits word | assemble in 16 bits word |

Those having skill in the art will recognize that decryption and encryption are performed according to the same block cipher routine and mapping method, using different keys. Decryption keys can be derived from encryption keys used to encrypt data blocks.

Other arrangements, configurations and methods for executing a block cipher routine should be readily apparent to a person of ordinary skill in the art. Other embodiments, combinations and modifications of this invention will occur readily to those of ordinary skill in the art in view of these teachings. For example, other routines in addition to the KASUMI block cipher can be executed using the reconfigurable processing architecture of the invention. Therefore, this invention is to be limited only be the following claims, which include all such embodiments and modifications when viewed in conjunction with the above specification and accompanying drawings.

What is claimed is:

1. A digital signal processing method, comprising:
configuring a portion of an array of independently reconfigurable processing elements for performing a block cipher routine; and
executing the block cipher routine on data blocks received at the configured portion of the array of processing elements.

2. The method of claim 1, wherein configuring a portion of the array of reconfigurable processing elements includes activating the portion with an activation signal.

3. The method of claim 2, wherein configuring a portion of the array of reconfigurable processing elements further includes loading a plurality of subkeys into the active processing elements.

4. The method of claim 2, wherein configuring a portion of the array includes loading a context instruction into one or more active processing elements, wherein the context instruction configures logical elements within a processing element for performing one of a plurality of subfunctions of the block cipher routine.

5. The method of claim 3, wherein loading a plurality of subkeys occurs at a first cycle of the block cipher routine.

6. The method of claim 4, wherein loading the context instruction is repeated at subsequent cycles.

7. The method of claim 4, wherein executing the block cipher routine includes executing one of the plurality of subfunctions according to the context instruction.

8. The method of claim 3, wherein configuring a portion of the array includes loading, at each of a plurality of subsequent cycles, a context instruction into one or more active processing elements, wherein each context instruction configures logical elements within a processing element for performing one of a plurality of subfunctions of the block cipher routine.

9. The method of claim 8, wherein executing the block cipher routine includes executing the plurality of subfunctions on the input data blocks according to the context instruction and using corresponding subkeys.

10. The method of claim 1, wherein the array of reconfigurable processing elements includes an M-row by N-column number of processing elements.

11. The method of claim 1, wherein the block cipher routine is the KASUMI block cipher.

12. The method of claim 3, wherein the plurality of subkeys include the KL, KO, and KI subkeys of the KASUMI block cipher.

13. The method of claim 4, wherein the plurality of subfunctions include the FL and FO subfunctions of the KASUMI block cipher.

14. The method of claim 13, wherein the plurality of subfunctions further includes the Fl subfunction within the FO subfunction.

15. The method of claim 13, wherein the plurality of subfunctions further includes one or more logic operations.

16. The method of claim 12, wherein the configured portion of the array includes at least four processing elements.

17. The method of claim 13, wherein the context instructions are loaded into two active processing elements.

18. The method of claim 11, wherein the data blocks received at the configured portion of the array are each 64 bits in length.

19. The method of claim 1, wherein the data blocks are non-encrypted, and wherein the method further comprises outputting encrypted data from the configured portion of the array of processing elements, wherein the encrypted data is encrypted according to the block cipher routine.

20. The method of claim 1, wherein the data blocks are encrypted, and wherein the method further comprises outputting decrypted data from the configured portion of the array of processing elements, wherein the decrypted data is decrypted according to the block cipher routine.

21. A digital signal processing method, comprising:
receiving an input data block at an array of independently reconfigurable processing elements;
configuring a portion of the array of processing elements for performing a block cipher routine; and
executing the block cipher routine on the input data block; and
outputting an output data block from the array, the output data block being transformed from the input data block by the block cipher routine.

22. The method of claim 21, wherein the input data block is unencrypted data, the block cipher routine is an encryption routine, and the output data block is encrypted data.

23. The method of claim 21, wherein the input data block is encrypted data, the block cipher routine is a decryption routine, and the output data block is decrypted data.

24. The method of claim 21, further comprising generating, with the configured portion of the array, a cipher key with which the block cipher routine is executed.

25. The method of claim 21, wherein configuring the portion of the array includes configuring one or more processing elements for performing a plurality of subfunctions of the block cipher routine.

26. The method of claim 25, wherein the block cipher routine is the KASUMI block cipher.

27. The method of claim 24, wherein the cipher key includes the KL, KO and KI subkeys of the KASUMI block cipher.

28. The method of claim 26, wherein the plurality of subfunctions includes the FL and FO subfunctions of the KASUMI block cipher.

29. The method of claim 28, wherein the FO subfunction further includes the Fl subfunction of the KASUMI block cipher.

30. The method of claim 21, wherein the array includes an M-row by N-column number of reconfigurable processing elements.

31. A digital signal processing apparatus, comprising:
a context memory for storing one or more context instructions for performing a block cipher routine; and
an array of independently reconfigurable processing elements, each of which is responsive to a context instruction for being configured to execute a portion of the block cipher routine.

32. The apparatus of claim 31, further comprising a data bus, connected to the array of processing elements, for providing input block data on which the block cipher routine is executed.

33. The apparatus of claim 32, further comprising a direct memory access controller for controlling the transfer of the input block data, and for controlling the output of the result of the block cipher routine executed on the input block data.

34. The apparatus of claim 31, wherein the array of processing elements includes an M-row by N-column number of processing elements.

35. The apparatus of claim 34, wherein the context memory includes a row context memory for instructing each of the M rows of processing elements.

36. The apparatus of claim 34, wherein the context memory includes a column context memory for instructing each of the N columns of processing elements.

37. The apparatus of claim 31, wherein the block cipher routine is the KASUMI block cipher.

38. The apparatus of claim 37, wherein at least one context instruction is adapted to configure one or more processing elements for generating one or more subkeys of the KASUMI block cipher.

39. The apparatus of claim 37, wherein at least one context instruction is adapted to configure one or more processing elements for executing one or more subfunctions of the KASUMI block cipher.

40. The apparatus of claim 39, wherein the one or more subfunctions include the FL and FO subfunctions.

41. The apparatus of claim 31, wherein each processing element includes one or more functional units that, when activated, perform a selectable logic function.
